(19) United States
(12) Patent Application Publication
(10) Pub. No.: US 2011/0178926 A1
(43) Pub. Date: Jul. 21, 2011

(54) Remote Variable Authentication Processing

(76) Inventors: Mike Lindelsee, Redwood City, CA (US); Olivier Brand, Walnut Creek, CA (US); James Dimmick, Foster City, CA (US); Benedicto Dominguez, San Bruno, CA (US)

(21) Appl. No.: 13/009,177

(22) Filed: Jan. 19, 2011

Related U.S. Application Data
(60) Provisional application No. 61/296,388, filed on Jan. 19, 2010.

(51) Int. Cl. G06Q 40/00

(52) U.S. Cl. 705/44

(57) ABSTRACT

A remote variable authentication processing system is disclosed. A sending entity initiates a remote payment using an alias over an initiation channel. The alias may be associated with one or more nicknames that identify portable consumer devices and metadata. The metadata describes which channels are available for authentication. The sending entity selects a nickname and an associated authentication channel. The sending entity authenticates with an issuer over the selected authentication channel.

### CROSS-REFERENCES TO RELATED APPLICATIONS

The present non-provisional application claims the benefit under 35 U.S.C. §119(e) of U.S. Provisional Patent Application No. 61/296,388, entitled “REMOTE PAYMENT INCLUDING VARIABLE AUTHENTICATION PROCESSING,” filed Jan. 19, 2010, the entire disclosure of which is incorporated herein by reference in its entirety for all purposes.

### BACKGROUND

Remote transactions often present a higher level of risk to a sending entity and a merchant. For the sending entity, also commonly referred to as a consumer, risk is introduced when sensitive information relating to a payment instrument is provided to a merchant that the sending entity cannot physically view or visit. Currently, a sending entity provides sensitive information, such as a credit card number, to a merchant. The sending entity is at risk that the sensitive information may be intercepted and fraudulently used by a malicious user. For the merchant, risk is introduced because the credit card may not be physically presented by the sending entity to the merchant. The merchant is at risk that a provided credit card is not truly owned by the sending entity.

Systems that authenticate the sending entity may lower risk. However, existing authentication systems authenticate the sending entity over a single authentication channel and do not permit a sending entity to select one of many authentication channels. Existing authentication systems also do not provide a method to conduct a remote transaction without disclosing sensitive information.

Thus, there is a need in the art for a remote variable authentication process that addresses the above concerns. Embodiments of the invention address these and other problems, individually and collectively.

### BRIEF SUMMARY

Embodiments of the invention disclosed herein include systems, technical architecture of the systems, and methods for a remote variable authentication processing system. A remote variable authentication processing system can be implemented using one or more computer apparatuses and databases.

One embodiment of the invention is directed to a method for receiving from a merchant a message comprising an alias, determining one or more consumer payment nicknames associated with the alias, and sending the one or more consumer payment nicknames and metadata associated with each of the one or more consumer payment nicknames to the merchant, the metadata describing authentication channels through which authentication of the one or more consumer payment nicknames can be conducted, wherein the merchant presents the one or more consumer payment nicknames and the authentication channels to a sending entity.

Another embodiment of the invention is directed to a method for receiving from the merchant an initiation channel identifier and analyzing the metadata to determine compatibility data describing which authentication channel is compatible with the channel described by the initiation channel identifier and sending the compatibility data to the merchant.

Another embodiment of the invention is directed to a method wherein if only one consumer payment nickname and authentication channel is compatible with the initiation channel identifier, then that consumer payment nickname and authentication channel is used to authenticate the consumer payment nickname.

These and other embodiments of the invention are described in further detail below.

### BRIEF DESCRIPTION OF THE DRAWINGS

FIG. 1 is a remote variable authentication processing system, according to an example embodiment.

FIG. 2 is a more detailed block diagram of a remote variable authentication processing system, according to an example embodiment.

FIG. 3 is process flow of a remote variable authentication initiation process, according to an example embodiment.

FIG. 4 is a process flow of web-based remote variable authentication process, according to an example embodiment.

FIG. 5 is a process flow of a remote variable authentication process where the initiation channel is different than the authentication channel, according to an example embodiment.

FIG. 6 is a process flow of a remote variable authentication process where the initiation channel is the same as the authentication channel, according to an example embodiment.

FIG. 7 is a diagram of a computer apparatus, according to an example embodiment.

### DETAILED DESCRIPTION

Embodiments of the invention are directed to systems, architectures of the systems, and methods conducting a remote variable authentication process.

In certain embodiments, the remote variable authentication process identifies a sending entity, determines a portable consumer device and an authentication channel selected by the sending entity out of a potential plurality of portable consumer devices and authentication channels, and conducts the authentication via the selected authentication channel, without exposing sensitive information to the merchant.

In the description below, reference is made to a “merchant.” A merchant can be an example of a “participant.” Other examples of participants can include entities that receive information from a sending entity, such as an alias or other identifying information. These entities may return payment instrument information that is locally stored or which is acquired by querying a payment processing network. A participant may send and receive sending entity portable consumer device information, and may operatively communicate with a merchant.

In the description below, reference is made to an “issuer.” An issuer can be an example of an “authorizing entity.” An authorizing entity may be an entity that may authorize a money transfer transaction. Other examples of an authorizing entity can include entities that manage or host sending entity accounts, such as an online value storage account provider, a bank, or a money transfer service.

A sending entity may initiate authentication by providing a “consumer identity alias” (“CIA”), also known as an alias, to a merchant to identify himself or herself. The merchant can then provide the CIA to a payment processing network. The payment processing network may lookup the CIA to determine consumer payment nicknames (“CPN”) associated with the CIA, where the customer payment nicknames identify portable consumer devices, such as a credit card. The CPNs may be tagged with metadata describing, among other parameters, authentication channels and initiation channels for which the portable consumer devices the CPNs identify may be authenticated through and for which authentication may be initiated through, respectively. The payment processing network may send the consumer payment nicknames and metadata to the merchant which then displays the data to the sending entity. The sending entity may then select a consumer payment nickname and an authentication channel. The selected consumer payment nickname and authentication channel are then communicated to the merchant, payment processing network, and an issuer. The sending entity may then authenticate with the issuer via the selected authentication channel. The merchant can then verify that the sending entity successfully authenticated with the issuer by querying the payment processing network and issuer. Upon successful verification, a payment transaction or money transfer may follow.

For example, to reduce the risk for both sending entity and merchant, the sending entity may authenticate over a preferred authentication channel without exposing sensitive information, such as a credit card number. As an example, the sending entity may provide a CIA, such as “ted@ted.com,” to a merchant via a merchant website to pay for the merchant's goods. The merchant may then query a payment processing network with “ted@ted.com,” which returns nicknames and metadata for the sending entity's actual credit cards, such as “My Blue card” and “My Red card,” that are associated with the CIA “ted@ted.com.” The metadata may indicate that “My Blue card” can be authenticated over SMS and “My Red card” may be authenticated by the web. The sending entity may select “My Blue card” and SMS authentication, because he or she cannot access a computer terminal at that moment. That selection is eventually communicated to the issuer, which asks the sending entity to authenticate “My Blue card” using a passcode over SMS. The sending entity may send a SMS message to the issuer with the passcode to authenticate. The merchant can verify that the sending entity authenticated with the issuer and then continue with a payment transaction with greater confidence.

As used herein, a “portable consumer device” may be a credit card, a debit card, a mobile phone, a pre-paid card, a mobile application, a payment instrument, a specialized application, or any portable device or software application capable of transferring funds. Such devices may include contact or contactless smart cards, ordinary credit or debit cards (with a magnetic strip and without an embedded microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like, where such devices may include an embedded or incorporated contactless chip or similar element.

The remote variable authentication process may support, and may precede, payment transactions conducted between the sending entity and the merchant, where the sending entity uses a portable consumer device to conduct a payment to the merchant. For example, the payment transaction may transfer funds from an account associated with the sending entity credit card to the merchant's merchant bank account, and may require issuer authorization of the payment transaction. Examples of such payment transactions may include the use of a credit card for shopping with an online merchant.

The remote variable authentication process may also support, and may precede, money transfers between portable consumer devices. In an example embodiment, a money transfer transfers funds from one account associated with a portable consumer device to another account associated with another portable consumer device. In an example embodiment, a money transfer may transfer funds from one credit card account to another credit card account. In another embodiment, the accounts may be associated with a mobile device, such as a mobile phone or a smart card. In an example embodiment, the accounts may be associated with a payment processing network and/or held by issuing entities or banks.

The remote variable authentication process may facilitate the authentication of sending entities involved in payment transactions and money transfers without exposing sensitive information, such as by using a CIA. As used herein, a CIA may be an alpha-numeric value, such as a username, and may be static or dynamic. CIAs may be used to identify a sending entity instead of sharing sensitive information, to preserve privacy and reduce the likelihood of fraud. A CIA may be associated with one or more portable consumer devices. In a further embodiment, a CIA may be a verifiable value, such as a phone number or an email address. For example, in a money transfer transaction, the sending entity may send money from the CIA “ted@ted.com” rather than by presenting a credit card number.

A CIA may be associated with one or more consumer payment nicknames. As used herein, a “consumer payment nickname” (“CPN”) may be any combination of letters, numbers, and characters, may be an alpha-numeric string, a token, or may be static or dynamic, and may identify a portable consumer device. A CPN may be a sending entity defined nickname, such as “My red card,” “My Yellow Points Card,” etc. A sending entity may enroll with the payment processing network to associate the CIA with one or more CPNs. The CPN may be used to identify a portable consumer device without revealing sensitive information, such as a credit card expiration date, a CW2, or a primary account number (“PAN”), also referring to a permanent account number or a personal account number. For example, a sending entity may share a CPN with a merchant, such as “First Credit Card,” to identify and use a portable consumer device without exposing that portable consumer device's PAN, credit card expiration date, or other sensitive information.

CPNs may be tagged or may be associated with metadata. The metadata for a CPN may describe, among other parameters, one or more authentication channels. The metadata may also describe an initiation channel and an initiation channel and authentication channel pair. An initiation channel is a channel through which a sending entity may request the initiation of authentication for the portable consumer device. In an example embodiment, the initiation channel is the channel via which the sending entity communicates with the merchant to send the CIA and to send and receive data about CPNs and metadata. An authentication channel may be a channel through which authentication is actually conducted for the portable consumer device. In an example embodiment, the authentication channel is the channel via which the sending entity and issuer communicate to share passcode and other authenticating data.

An initiation channel and authentication channel pair may describe a valid combination of an initiation channel and an authentication channel through which the sending entity may initiate and conduct authentication for a particular portable consumer device, respectively. For example, the sending entity may initiate authentication via SMS and may conduct the authentication using a CSR. In this case, SMS/CSR is an initiation channel and authentication channel pair that indicates that for a particular portable consumer device, authentication initiation may be communicated via SMS and authentication may be conducted using an IVR process. In an example embodiment, if an authentication channel is not listed in an initiation channel and authentication channel pair with a particular initiation channel, then that authentication channel may not be used to authenticate the portable consumer device if the particular initiation channel is used to initiate the authentication. In such as case, the authentication channel is incompatible with the initiation channel. The metadata may include an indicator describing whether the authentication channel is compatible with the initiation channel. In a further embodiment, the metadata may describe just authentication channels. The metadata may also indicate which authentication channel is the preferred authentication channel for a particular portable consumer device. The metadata may also indicate whether each of the CPNs is eligible for authentication via a “one-time password.” A one-time password may be a password that is valid for a single transaction or authentication session.

As used herein, an “initiation channel” can refer to a communication path for starting an authentication process. An “authentication channel” can refer to a communication path that is used to authenticate an entity. Initiation and authentication channels may use any suitable processes or devices. For example, initiation channels and authentication channels may use any of the following: the web, a mobile web, a mobile application, a short messaging service (“SMS”), an interactive voice response (“IVR”) process, an unstructured supplementary service data (“USSD2”), and/or a customer service representative (“CSR”). For example, if an initiation channel uses SMS and an authentication channel uses a CSR, then a sending entity may initiate authentication via SMS and authenticate using a CSR. In an example embodiment, the initiation channel can be the same as the authentication channel. In a further embodiment, the initiation channel is different from the authentication channel. In a further embodiment, any combination of valid channels may be used as the initiation and authentication channels. In an example embodiment, the authentication channel may also identify an address, location, or number by which the sending entity may be contacted. For example, the authentication channel may also indicate a sending entity phone number, IP address, application serial number, etc.

The CPN may be associated with a PAN or other portable consumer device identifying information. The PAN or other portable consumer device identifying information may be analyzed to resolve the issuer. For example, a PAN may be analyzed to derive an issuer identification number. The issuer may be an issuing bank that issued the portable consumer device to the sending entity. In an example embodiment, the issuer also provides an authentication service. The sending entity may initiate authentication with the issuer over the sending entity selected authentication channel. In a further embodiment, the sending entity enrolls with the issuer.

The remote variable authentication processing system may comprise the sending entity, the merchant, the payment processing network, and the issuer (and computer apparatuses, associated with the foregoing entities). The sending entity may communicate with the merchant, payment processing network, and issuer via the initiation and authentication channels. For example, a sending entity may send a message via a merchant website. The sending entity may identify himself or herself by providing the merchant a CIA. The merchant may then query the payment processing network to verify that the CIA is registered with the payment processing network and that it is associated with one or more CPNs.

The payment processing network may respond to the merchant by looking up the CIA and returning a list of CPNs associated with the CIA and their associated metadata. In an example embodiment, all associated CPNs are sent to the merchant. In a further embodiment, all associated CPNs are sent to the merchant, but those CPNs whose metadata indicate an authentication channel that is incompatible with the initiation channel used by the sending entity to initiate the authentication are marked as incompatible. In another embodiment, the payment processing network may analyze the list of CPNs and return only those CPNs whose metadata indicate an authentication channel that is compatible with the initiation channel used by the sending entity to initiate the authentication.

If more than one CPN is associated with the provided CIA, the merchant may present the one or more CPNs, along with their authentication channels, to the sending entity. It may be possible to show the same CPN multiple times, once for each authentication channel. The one or more CPNs may be sent to the sending entity via the initiation channel. In an example embodiment, the merchant displays only the CPNs and the authentication channels compatible with the initiation channel used by the merchant and sending entity. In a further embodiment, only compatible authentication channels are selectable by the sending entity. The sending entity may then select one CPN and authentication channel to use in the authentication process and sends that selection to the merchant via the authentication channel. If no CPN is associated with the provided CIA, then the transaction may be terminated. If only one CPN and authentication channel is associated with the provided CIA, then that CPN and authentication channel is used and it may be that no list of CPNs is presented to the sending entity. In this instance, the CPN and authentication channel may be presented to the sending entity for approval. Its may be possible that no CPN or authentication channel is compatible and presented to the sending entity.

Upon the merchant determining the one CPN and authentication channel to use in the authentication process, the merchant then sends a message to the payment processing network to initiate the authentication request. In an example embodiment, the merchant may request from the payment processing network the address where the sending entity may be redirected in order to authenticate. In a further embodiment, the merchant may be informing the payment processing network of the sending entity selected authentication channel, which can then be further communicated by the payment processing network to the issuer.

Upon the payment processing network receiving the message from the merchant, the payment processing network analyzes the one CPN and derives an issuer. The payment processing network may analyze the CPN and determine the associated PAN or portable consumer device and then determine the issuer. After determining the issuer, the payment processing network may send a message to the issuer identifying the sending entity, the portable consumer device and the authentication channel. In an example embodiment, the payment processing network may send the CIA and CPN to the issuer to protect sensitive information.

Upon receiving the message from the payment processing network, the issuer may analyze the contents and determine the associated portable consumer device, the sending entity, and the authentication channel. The issuer may then prepare a response message to return to the payment processing network. The response message may indicate that authentication will begin with the issuer, or it may indicate an authentication address that the merchant should redirect the sending entity to in order for the sending entity to authenticate. The payment processing network may receive the message from the issuer and send a further message with similar content to the merchant.

After the merchant receives the message from the payment processing network the process flow varies depending on the sending entity selected initiation channel and authentication channel. The sending entity could have selected a web-based authentication channel and a web-based initiation channel, an authentication channel that was different from the initiation channel, or an authentication channel that is the same as the initiation channel.

In a web-based authentication scenario, the merchant communicates the authentication address to the sending entity and redirects the sending entity to the authentication address. This may direct the sending entity to an authentication system operated by the issuer. Here, the sending entity may authenticate with the issuer by providing information such as a passcode. After authentication, the issuer may then redirect the sending entity back to the merchant. The merchant may then query the payment processing network to query the issuer to verify that the sending entity successfully authenticated with the issuer. If the sending entity successfully authenticated and a message describe the successful authentication is relayed to the merchant, then the merchant sends confirmation of authentication to the sending entity and may continue with authorizing a payment transaction or money transfer.

In the scenario where the initiation channel and the authentication channel are different, then the issuer will contact the sending entity through the sending entity selected authentication channel. The issuer and sending entity will then communicate to authenticate the sending entity, such as by providing a passcode. The issuer may send an authentication response indicating an authentication result to the sending entity. In the meantime, the merchant may continually query the payment processing network to query the issuer to determine if the sending entity has successfully authenticated. The merchant may query the payment processing network for a set period of time while waiting for the sending entity to authenticate over the authentication channel. Upon the merchant receiving notice from the issuer and the payment processing network that the sending entity has successfully authenticated, the merchant then sends confirmation of authentication to the sending entity and may continue with authorizing a payment transaction or money transfer.

The scenario where the initiation channel and the authorization channel are the same operates similarly to the scenario where the initiation channel and the authorization channel are different, except that the issuer contacts the sending to initiate the authentication over a channel that is the same as the initiation channel.

Other specific examples of embodiments of the invention are described in further detail below.

### I. Systems

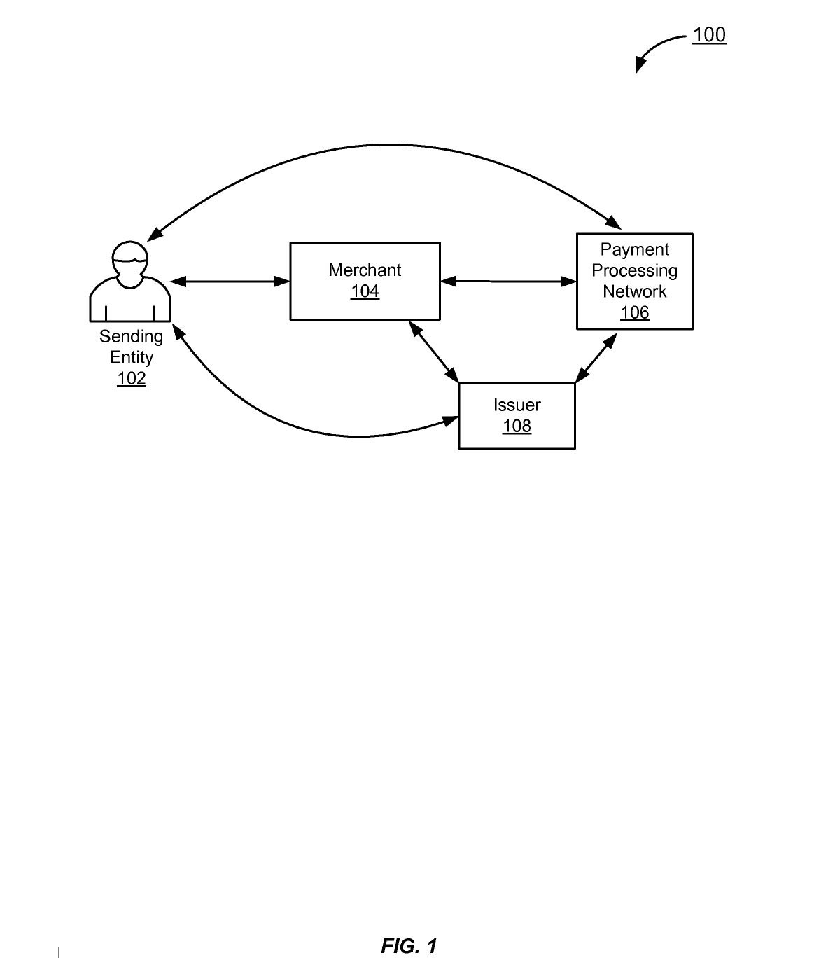

FIG. 1 is a remote variable authentication processing system 100, according to an example embodiment. The remote variable authentication processing system 100 comprises a sending entity 102, a merchant 104, a payment processing network 106, and an issuer 108. Although only one sending entity 102, one merchant 104, one payment processing network 106, and one issuer 108 are shown, there may be any suitable number of any of these entities in the token based transaction authentication system 100.

The sending entity 102 can be a consumer that uses the portable consumer device to conduct a payment transaction or money transfer, and may further operate one or more user devices, including a mobile device which may comprise a mobile phone. The sending entity 102 may be an individual, or an organization such as a business, that is capable of purchasing goods or services.

As used herein the merchant 104 may refer to any suitable entity or entities that can conduct a transaction with the sending entity 102. The merchant 104 may have a physical location which sells goods and services to the sending entity 102. The merchant 104 may use an e-commerce business to allow the transaction to be conducted by the merchant through the Internet. Other examples of a merchant 104 include a department store, a gas station, a drug store, a grocery store, or other suitable business.

The payment processing network 106 refers to a network of suitable entities that have information related to an account associated with the portable consumer device. This information includes data associated with the account on the portable consumer device such as profile information, data, CIAs, CPNs, metadata, and other suitable information.

The payment processing network 106 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. The server computer may use any of a variety of computing structures, arrangements, and compilations for servicing the requests from one or more client computers.

The payment processing network 106 may include data processing subsystems, networks, and operations used to support and deliver authorization services, exception file services, and clearing and settlement services. An exemplary payment processing network 106 may include VisaNet™. Networks that include VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 106 may use any suitable wired or wireless network, including the Internet.

The issuer 108 refers to any suitable entity that may open and maintain an account associated with the portable consumer device used by the sending entity 102. Some examples of issuers 108 may be a bank, a business entity such as a retail store, or a governmental entity. The issuer 108 may provide authentication services, such as allowing a sending entity 102 to provide a passcode to authenticate.

The sending entity 102 may be in communication with the merchant 104. In an example embodiment, the merchant 104 may be an online merchant which the sending entity 102 communicates with via the Internet or a mobile network. The sending entity 102 may communicate with the merchant 104 via an initiation channel or communications network. The sending entity 102 may communicate with the merchant 104 to provide and/or receive a CIA, a CPN, an initiation channel identifier, an authentication address to be redirected to, and acknowledgement of a successful authentication or a selected CPN and authentication channel.

The sending entity 102 may also be in communication with the issuer 108. The sending entity 102 communicates with the issuer 108 over an authentication channel. In an example embodiment, the sending entity 102 may authenticate with the issuer 108 by providing a passcode. In an example embodiment, the sending entity's 102 portable consumer device may have been issued by the issuer 108.

The merchant 104 and the issuer 108 may be in communication with a payment processing network 106. The merchant 104 may be in communication with the payment processing network 106 to determine the CPNs associated with a CIA, to determine the issuer associated with a CPN, to receive various keys and tokens necessary to authenticate the sending entity, and to receive CPN metadata. The merchant 104 may communicate with the payment processing network 106 over a communication network, such as the Internet or any of the authentication/initiation channels.

The payment processing network 106 may communicate with the issuer 108 to determine an authentication address in which to redirect the sending entity 102 and to verify that the sending entity 102 successfully authenticated with the issuer 108. The payment processing network 106 may also communicate with the issuer 108 to communicate the authentication channel the sending entity 102 wishes to authenticate on and the CPN/portable consumer device to authenticate. The payment processing network 106 may send account funding transaction messages and original credit transaction messages to the issuer 108 and the merchant's bank in order to effectuate a money transfer. The payment processing network 106 may also send debit and deposit messages to the issuer 108/merchant bank to effectuate a payment transaction. The issuer 108 may communicate with the payment processing network 106 over a communication network, such as the Internet or any of the authentication/initiation channels.

The sending entity 102 may also communicate with the payment processing network 106. The sending entity 102 may communicate with the payment processing network 106 after the authentication process to conduct a payment transaction or money transfer, and may also communicate with the payment processing network 106 before the authentication to register for authentication services, such as by providing CIA and CPN data. In an example embodiment, the sending entity 102 may communicate with the payment processing networking 106 during the authentication process to provide and receive authentication data. The sending entity 102 may communicate with the payment processing network 106 over a communication network, such as the Internet or any of the authentication/initiation channels.

The merchant 104 may also communicate with the issuer 108. In an example embodiment, the merchant 104 may receive the status of an authentication request from the issuer 108. The merchant 104 may communicate with the issuer 108 over a communication network, such as the Internet or any of the authentication/initiation channels.

Communications between entities in the remote variable authentication process system 100 may also be conducted via the web, a mobile network, an intranet, SMS/IVR, a plain old telephone system, email, USSD-2, APIs, tailored messages, a specialized application, a communications network or any of the listed initiation or authentication channels.

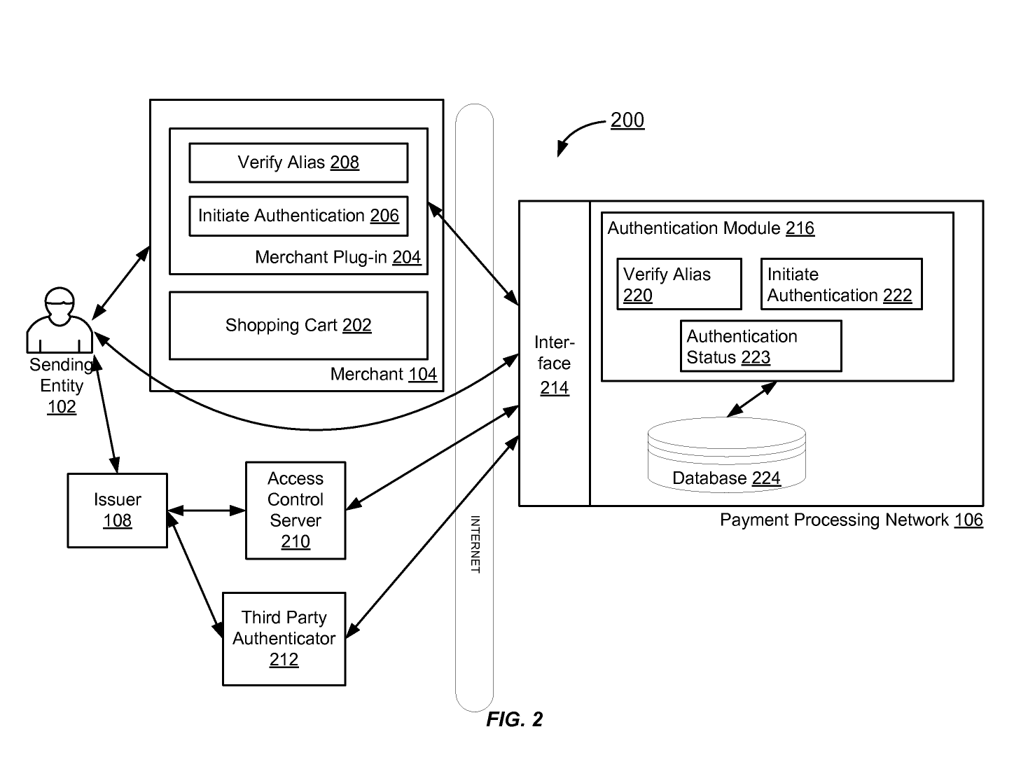

FIG. 2 is a more detailed block diagram of a remote variable authentication processing system 200, according to an example embodiment. The remote variable authentication system 200 may comprise the sending entity 102, the merchant 104, the issuer 108, an access control server 210, a third party authenticator 212, the payment processing network 106 and a database 224.

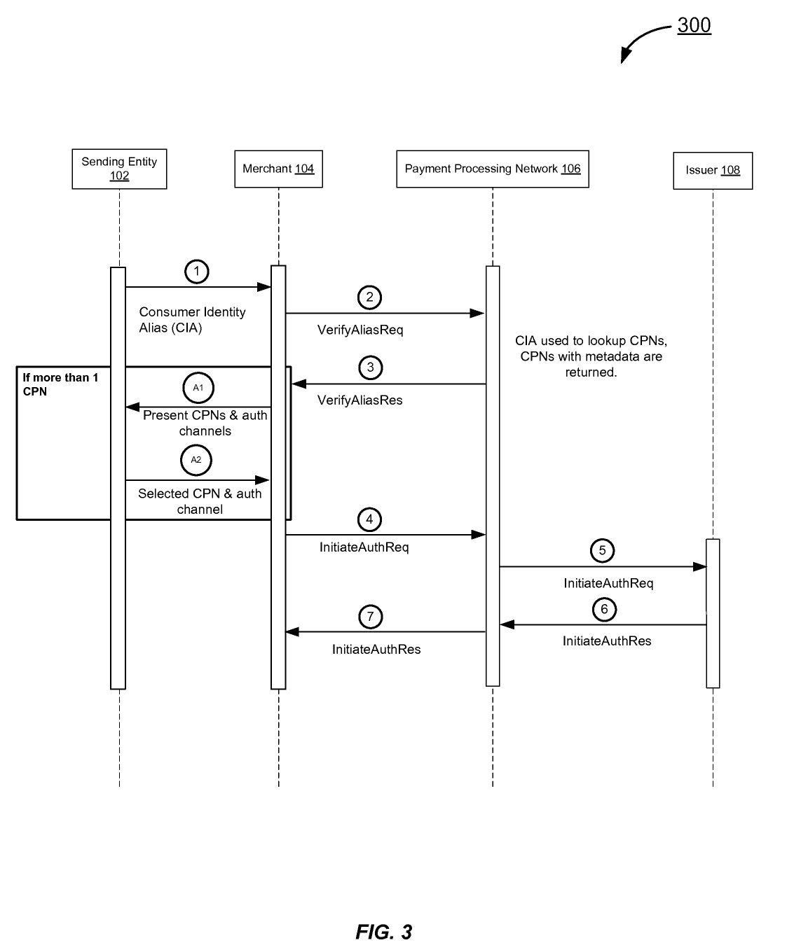

The merchant 104 may comprise a merchant plug-in 204 and a shopping cart 202. The merchant 104 may communicate with the payment processing network 106 via the merchant plug-in 204. The merchant plug-in 204 may be a module which implements logic to support an authentication protocol, such as the protocol described in FIGS. 3-6. The merchant plug-in 204 may comprise a verify alias module 208 and an initiate authentication module 206. These modules may receive messages from and send messages to the payment processing network 106. The verify alias module 208 may send messages to the payment processing network 106 requesting CPNs and providing a CIA. The verify alias module 208 may also process the response and manage the presentation of the CPNs and authentication channels to the sending entity 102. The initiate authentication module 206 may send messages to the payment processing network 106 requesting the authentication address or describing an sending entity 102 selected authentication module, and may analyze any response, such as by redirecting the sending entity 102 to the authentication address. A shopping cart 202 may be a module that presents or stores a list of items or goods that the sending entity 102 wishes to purchase from the merchant 104. The verify alias module 218 and initiate authentication module 206 may communicate via the merchant plug-in 204. The merchant plug-in 204 may communicate with the payment processing network 106 via the Internet, or any of the initiation channels/authentication channels, and through the payment processing network's interface 214.

The issuer 108 may communicate with the payment processing network interface 214 via the access control server 210 or the third party authenticator 212. The access control server 210 is a server operated or facilitated by the issuer 108 that may authenticate holders of portable consumer devices. The third party authenticator 212 may be used by the issuer 108 to perform authentication operations if the issuer 108 does not posses an access control server 210 or does not support authentication directly. The third party authenticator 212 may be a server or service provider that can perform the authentication steps for the issuer 108. The access control server 210 and the third party authenticator 212 may communicate with the payment processing network 106 and the issuer 108, through a payment processing network interface 214, and via the Internet or any of the initiation or authentication channels.

The payment processing network may comprise the interface 214, an authentication module 216 and the database 224. The payment processing network interface 214 may possess modules that support various communication protocols. The payment processing network interface 214 may posses an XML/HTTP and a SOAP (simple object access protocol) module to receive, parse, and analyze messages sent via XML, HTTP, SOAP, and other protocols. The XML/HTTP and SOAP module may also package and create outgoing messages in various formats and according to various protocols, such as XML, HTTP, and SOAP.

The authentication module 216 may comprise a verify alias module 220, an initiate authentication module 222, and an authentication status module 223. The initiate authentication module 222 may receive and send messages related to the verifying of a CIA and the initiation of authentication. The verify alias module 220 may receive messages from the merchant 104 requesting a CIA, such as messages sent from the merchant verify alias module 208 requesting CPNs and metadata. In an example embodiment, the verify alias module 220 may receive a verify alias request message from a merchant 104 that comprising a CIA. The verify alias module 220 may respond to the merchant 104 by sending a message comprising CPNs and associated metadata. The CPN and CIA data may be stored and retrieved from the database 224 by the verify alias module 220. The verify alias module 220 may determine the compatibility of the authentication channels based on the initiation channel identifier and the metadata.

The payment processing network 106 may also be a remote directory providing remote services.

### II. Methods

### A. Authentication Initiation

FIG. 3 is process flow of a remote variable authentication process, according to an example embodiment. At operation 1, the sending entity 102 initiates authentication by sending a message to the merchant 104 comprising a CIA. The message may be sent via an initiation channel. The sending entity 102 may prefer to provide a CIA, as opposed to a PAN, for security or convenience factors. The sending entity 102 may also provide additional information to the merchant 104, such as an initiation channel identifier that identifies the initiation channel by which the message was sent through. The message may be sent via the shopping cart 202. For example, the message may contain the CIA “ted@ted.com” and may contain the initiation channel identifier describing the web channel. The initiation channel identifier may also describe a specific method to contact the sending entity 102, such as a phone number, an IP address, etc.

Upon receiving the message sent in operation 1 from the sending entity 102, the merchant 104 may analyze the contents of the received message. The message sent by the sending entity 102 may be received by the merchant plug-in 204 and the verify alias module 208. At operation 2, the merchant may then send the received CIA in a message to the payment processing network 106 to request the CPNs associated with the CIA. The message may also comprise the initiation channel identifier. The message may be sent by the verify alias module 208. In an example embodiment, the message is a verify alias request message. For example, the merchant 104 can send a message with the CIA “ted@ted.com” to the payment processing network 106, and the initiation channel identifier would describe the web channel.

The payment processing network 106 receives the message from the merchant 104 sent in operation 2 and analyzes the contents of the received message. The message may be received by the payment processing network interface 214 and analyzed by the transaction module 216 and the verify alias module 220. The verify alias module 220 may look up the CIA and retrieve associated CPNs by querying the database 224 with the CIA for associated CPNs. In an example embodiment, the CPNs are associated with the CIA during a sending entity 102 enrollment process with the payment processing network 106, where the sending entity 102 may create a CIA and associate one or more portable consumer devices with the CIA by creating a CPN for each portable consumer device. For example, the payment processing network 106 may look up the CIA “ted@ted.com” in the database 224 and determine the CPNs “My Red card,” My Blue card,” and “My Green debit card” are associated.

In addition, the payment processing network 106 may retrieve CPN metadata from the database 224 indicating which authentication channels the portable consumer device represented by the CPN may be authenticated through. In an example embodiment, authentication channels are described in an initiation channel and authentication channel pair that determines which authentication channels are available given the initiation channel the authentication was initiated through. For example, authentication via the SMS channel may be available when the authentication was initiated on an SMS or web channel, but not via a CSR channel. In a further embodiment, authentication channels are described without an accompanying initiation channel. As an example, metadata may describe that the CPN “My Blue card” can be authenticated by the SMS channel when authentication was initiated via the web.

In operation 3, the payment processing network 106 may send a message to the merchant, the message comprising the CPNs and the metadata that are associated with the CIA sent in operation 2, to the merchant 104. The message may be sent by the verify alias module 220 and be received by the merchant plug-in 204 and analyzed by the merchant verify alias module 208. In an example embodiment, the payment processing network 106 may send only the CPN and authentication channels that are compatible under a web-based authentication channel. In a further embodiment, the payment processing network 106 and the verify alias module 220 analyze the initiation channel identifier and send only the compatible CPNs and authentication channels to the merchant 104. In a further embodiment, the payment processing network 106 and the verify alias module 220 may analyze the initiation channel identifier and mark incompatible channels as incompatible before sending the CPN metadata to the merchant 104. In an example embodiment, the message is a verify alias response message. The message may also comprise the initiation channel identifier. For example, the payment processing network 106 may send a message with the CPN “My Blue card” and the authentication channels “SMS” and “web.”

The merchant 104 may receive the message sent in operation 3 containing the CPNs and metadata from the payment processing network 106 and may analyze the message. The message may be received by the merchant plug-in 204 and the verify alias module 208. The merchant 104 may present the CPNs and authentication channels to the sending entity 102. If more than one compatible CPN and authentication channel is received, then at operation A1 the compatible CPNs and authentication channels may be presented to the sending entity 102. At operation A2, the sending entity 102 may select one CPN and authentication channel and send the selection back to the merchant 104. The sending entity 102 may also provide information with the selection of the authentication channel that may describe how to contact the sending entity 102 during the authentication method, such as a phone number or IP address. In an example embodiment, only compatible CPNs and authentication channels, given the sending entity initiation channel, may be presented to the sending entity 102. If no CPNs are eligible, then the authentication process may be canceled. If only one CPN and authentication channel are compatible, then that CPN is used and may request the sending entity 102 to authorize before continuing with the authentication. The sending entity 102 may be presented a preferred authentication channel for a CPN, if such a preference exists. The merchant 104 may communicate with the sending entity 102 via the initiation channel. The message may be sent via the verify alias module 208. For example, the sending entity 102 may be presented that the CPN “My Blue card” may be authenticated using “SMS” or “web.” The sending entity 102 may then select “My Blue card” and “SMS.” A sending entity 102 may also select a phone number in which to send the SMS.

The merchant 104 may send a message to the payment processing network 106 at operation 4, identifying the sending entity 102 selected CPN and authentication channel. The message may be sent via the verify alias module 208 of the merchant plug-in 204. The message may also comprise information identifying the sending entity 102 and the initiation channel identifier. In an example embodiment, the message may be an initiate authentication request message. For example, the message may comprise the CPN “My Blue card” and the authentication channel “SMS,” and a sending entity phone number.

The payment processing network 106 may receive the message from the merchant 104 sent at operation 4 and analyze the message contents. The payment processing network interface 214 may receive the message and the initiate authentication module 222 may analyze the message. The CPN may be analyzed to determine the issuer 108. The CPN may be used to query the database 224 to determine an associated PAN and an issuer identification number may be derived from the PAN.

The payment processing network 106 may at operation 5, send a message to the issuer 108. The message may be sent by the initiate authentication module 222. The message may comprise the user selected CPN and authentication channel. The message may also comprise the PAN associated with the CPN and the initiation channel identifier. The message may also comprise the CIA. The message sent to the issuer 108 may be requesting an authentication address in which to direct the sending entity 102 to in order for the sending entity 102 to authenticate with the issuer 108 or to request authentication over the selected authentication channel. For example, the payment processing network 106 may send a message indicating that the sending entity 102 wishes to authentication via SMS for the CPN “My Blue Card.” In an example embodiment, the message is an initiate authentication request message sent by the initiate authentication module 222.

The issuer 108 receives the message sent from the payment processing network 106 in operation 5 and analyzes the content. The issuer 108 may use the CPN to determine the authentication address. The authentication address may direct to the issuer 108, an issuer access control server 210, or a third party authenticator 212. The issuer 108 may also prepare to authenticate the sending entity 102 over the selected authentication channel. The issuer 108 may then send a message to the payment processing network 106. In an example embodiment, the message may comprise the authentication address. In a further embodiment, the message may acknowledge that authentication over the selected authentication channel will begin. In an example embodiment, the message is an initiate authentication response message. For example, the message may comprise the authentication address “authenticate.ted.com.”

The payment processing network 106 receives the message sent from the issuer 108 in operation 6 and may analyze the content. The message may be received by the payment processing network interface 214 and analyzed by the initiate authentication module 222. At operation 7, the payment processing network 106 sends a message to the merchant 104. The message may be sent by the initiate authentication module 222. In an example embodiment, the message may comprise the authentication address. In a further embodiment, the message may acknowledge that authentication over the selected authentication channel will begin. The message may be sent via the access control server 210 or the third party authenticator 212. In an example embodiment the message is an initiate authentication response message.

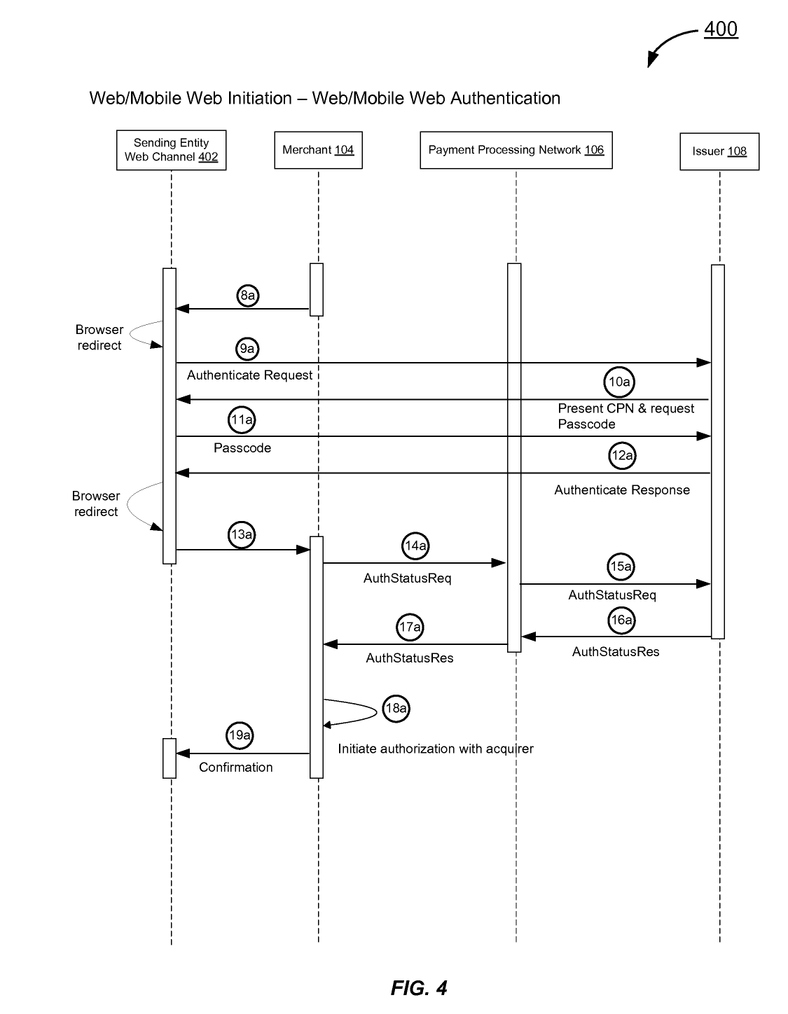

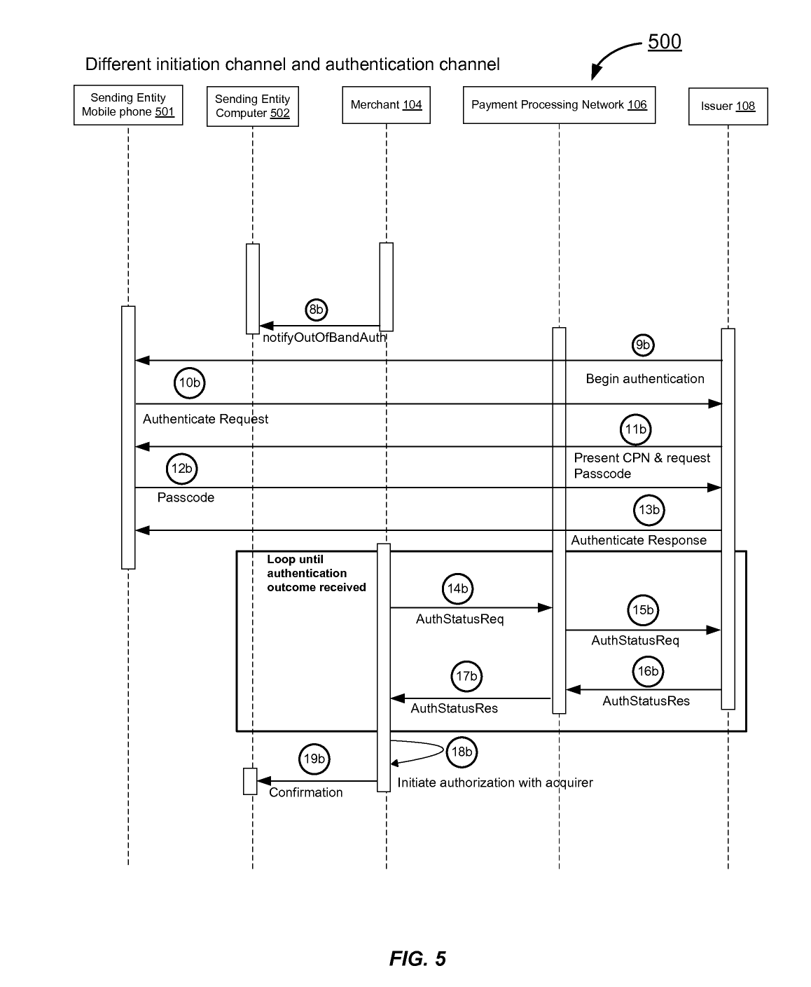

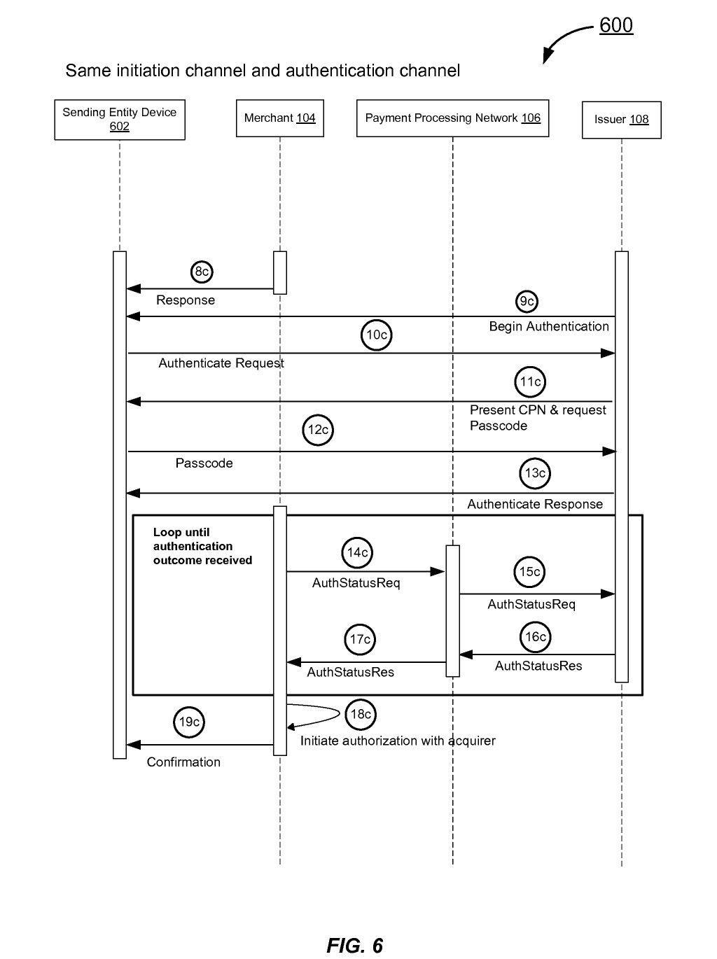

The merchant 104 receives the message from the payment processing network 106 sent in operation 7 and may analyze its contents. The message may be received by the merchant plug-in 204 and analyzed by the initiate authentication module 206. After this point, the operations vary depending upon the initiation channel and authentication channel. Separate operational process flows may apply for web-based initiation and authentication, when the initiation channel and authentication channel are the same and not web-based, and when the initiation channel and authentication are different. Web-based initiation and authentication is further described in FIG. 4. Authentication when the initiation channel and authentication channel are different is further described in FIG. 5. Authentication when the initiation channel and the authentication channel are the same is further described in FIG. 6.

### B. Web-Based Authentication

FIG. 4 is a process flow of a web-based remote variable authentication process, according to an example embodiment. This process flow may describe the situation where the initiation and authentication channels are web-based, such as communicating via the Internet or a mobile web.

Starting from where FIG. 3 ended, at operation 8a, the merchant 104 sends a message to the sending entity 102 that redirects the sending entity 102 to the authentication address. This message may be sent by the merchant plug-in 204 and the initiate authentication module 206. The merchant 104 may send a server side HTTP redirection (30× code). The authentication address may direct the sending entity 102 from a merchant webpage (not shown) to the issuer 108 or the access control server 210 or the third party authenticator 212. The message may comprise information identifying the sending entity 102, the CPN, the initiation channel identifier, and the authentication channel. At operation 9a, the sending entity 102 sends a message requesting authentication to the issuer 108. This message may be sent via the sending entity 102 selected authentication channel.

The issuer 108 receives the message sent by the sending entity 102 in operation 9a and analyzes its contents. The issuer 108 may receive the message via the access control server 210 or the third party authenticator 212. At operation 10a the issuer 108 may send a message to the sending entity 102 that presents the CPN and requests the sending entity 102 to provide a passcode. In an example embodiment, the issuer 108 may request other authenticating data, such as a response to a question. The sending entity 102 receives the message sent in operation 10a and responds in operation 11 a with a message. The message may comprise the passcode. The issuer 108 receives the message sent in operation 11 a and verifies that it matches the data associated with the CPN. For example, the issuer may determine whether the message contains a passcode that matches the passcode associated with the CPN. In operation 12a, the issuer 108 sends a message to the sending entity 102 with the results of the authentication request. The message may also contain a redirect command to the sending entity 102 browser to redirect to the merchant 104.

At operation 13a, the sending entity 102 is redirected to the merchant 104. The merchant 104 then queries to see if the sending entity 102 successfully authenticated. The merchant 104 sends a message to the payment processing network 106 at operation 14a inquiring about the authentication status of the sending entity 102. In an example embodiment, the message may be an authentication status request message.

The payment processing network 106 receives the message from operation 14a. The authentication status module 223 may analyze the message and may determine the issuer 108. At operation 15a the authentication status module 223 sends a message to the issuer 108 inquiring about the authentication status of the sending entity 102. In an example embodiment, the message may be an authentication status request message send by the authentication status module 223.

The issuer 108 receives the message sent in operation 15a and may analyze its contents. At operation 16a the issuer 108 sends a message to the payment processing network 106 that contains the authentication status of the sending entity 102. In an example embodiment, the message is an authentication status response message. The payment processing network 106 receives the message sent in operation 16a. The message may be analyzed by the authentication status module 223. The authentication status module 223 then sends a message to the merchant 104 at operation 17a with the authentication status of the sending entity 102. In an example embodiment, the message is an authentication status response message. The merchant 104 analyzes the message. If the authentication was successful, the merchant 104 may initiate a payment transaction with an acquirer and issuer or a money transfer transaction. At operation 19a the merchant 104 may send a confirmation of authentication to the sending entity 102.

### C. Different Initiation Channel and Authentication Channel

FIG. 5 is a process flow of a remote variable authentication process where the initiation channel is different than the authentication channel, according to an example embodiment. This may describe the situation where the initiation and authentication channels are different, such initiating the authentication via web and conducting the authentication via SMS. Other potential initiation channel and authentication channel pairs include: web/mobile web, SMS/IVR, USSD2/IVR, SMS/mobile application, USSD2/mobile application, CSR/IVR, IVR/mobile application, and CSR/mobile application. For the sake of illustration, we assume a web/SMS initiation and authentication channel pair. In an example embodiment, the mobile web, SMS, USSD2, IVR, mobile application, and CSR methods may be conducted via a mobile phone device.

The sending entity mobile phone 501 is the mobile phone of the sending entity 102 that receives and sends SMS messages to authenticate with the issuer 108. The sending entity computer 502 is the computer of the sending entity 102 connected to the web from which authentication was initiated. The sending entity mobile phone 501 may be an embodiment of a device communicating over the SMS channel. The sending entity computer 502 may be an embodiment of a device communicating over the web channel.

Starting from where FIG. 3 ended, the process of FIG. 5 begins at operation 8b, where the merchant 104 sends a message to the sending entity computer 502. The message may notify the sending entity 102 that an out of band authentication will occur, meaning that an authentication will occur on a channel other than the initiation channel. The message may be sent via the initiation channel. The sending entity computer 502 may be contacted using information derived from the initiation channel identifier. For example, the initiation channel identifier may describe a phone number, an IP address, or other data, through which the issuer 108 may contact the sending entity computer 502.

At operation 9b, the issuer 108 then begins authentication by contacting the sending entity mobile phone 501. The sending entity mobile phone 501 may be contacted from information derived from the initiation channel identifier, such as a phone number or an IP address. For example, if the authentication channel uses SMS, the issuer 108 may send a SMS to the sending entity mobile phone 501 via SMS. If the authentication channel uses an IVR process, then the issuer 108 will initiate a call to the sending entity mobile phone 501. If the authentication channel uses a mobile application, then the issuer 108 may send a message to the mobile application via the sending entity mobile phone 501. The issuer 108 may indicate that it is ready to begin authentication and to whom the sending entity 102 should respond to in order to authenticate.

At operation 10b, the sending entity mobile phone 501 receives the information sent in operation 9b. The sending entity 102 via the sending entity mobile phone 501, responds and communicates an authentication request to the issuer 108.

The issuer 108 receives the communication from the sending entity mobile phone 501 in operation 10b. At operation 11 b the issuer 108 communicates to the sending entity mobile phone 501 the CPN and requests the sending entity 102 to provide a passcode or a response to authenticate. The sending entity mobile phone 501 receives the communication of operation 11 b and responds in operation 12b with a passcode or a response. The issuer 108 receives the passcode or response communicated in operation 12b and verifies that it matches the passcode or response associated with the CPN. In operation 13b, the issuer 108 sends a message to the sending entity mobile phone 501 with the results of the authentication request.

Operations 14b, 15b, 16b, and 17b execute and loop continuously, for a pre-determined amount of time, during and after operations 9b, 10b, 11 b, 12b, and 13b, to check the authentication status of the sending entity 102. After operation 8b, the merchant 104 is waiting for the sending entity 102 to authenticate with the issuer 108. At operation 14b, the merchant 104 may communicate to the payment processing network 106 requesting the status of the authentication. In an example embodiment, the communication is an authentication status request message. The payment processing network 106 receives the communication of operation 14b, and may communicate to the issuer in operation 15b requesting the status of the authentication. The authentication status module 223 may receive the communication of operation 14b and communicate the message of operation 15b. In an example embodiment, the communication is an authentication status request message.

The issuer 108 may receive the communication of operation 15b. The issuer 108 may then communicate to the payment processing network 106, at operation 16b, the authentication status. The authentication status may indicate that the authentication succeeded, has failed, is in process, or is waiting for a response from the sending entity 102. In an example embodiment, the communication is an authentication status response message. The merchant 104 may receive the communication of operation 17b and analyze the contents. If the merchant 104 determines that the authentication was successful, then in operations 18b, the merchant 104 continues with a payment transaction or money transfer and sends confirmation of the authentication to the sending entity computer 502 in operation 19b. If the authentication was not successful, is in process, or is waiting for a response from the sending entity mobile phone 501, then operations 14b-17b loop until a pre-determined time period expires.

### D. Same Initiation Channel and Authentication Channel

FIG. 6 is a process flow of a remote variable authentication process where the initiation channel is the same as the authentication channel, according to an example embodiment. This may describe the situation where the initiation and authentication channels are the same, such as initiating and conducting the authentication via IVR. The operations of FIG. 6 are similar to that of FIG. 5, except that instead of a separate sending entity initiation device and sending entity authentication device, there is only one sending entity device 602. The sending entity device 602 may be a mobile phone, a computer, or any device capable of receiving and sending messages to the issuer 108. Information to contact the sending entity device 602 may be derived from the initiation channel identifier. For example, the initiation channel identifier may describe an email address through which the issuer 108 contact the sending entity device 602.

At operation 8c, where the merchant 104 sends a message to the sending entity device 602. The message may be a response to the sending entity device 602 that authentication will occur.

At operation 9c, the issuer 108 then begins the authentication by contacting the sending entity device 602. For example, if the combined channel uses SMS, the issuer 108 may send a SMS to the sending entity device 602 via SMS. If the combined channel uses an IVR process, then the issuer 108 will initiate a call to the sending entity device 602 via phone. If the combined channel uses a mobile application, then the issuer 108 may send a message to the mobile application via the sending entity device 602. This message may indicate that the issuer is ready to begin authentication and to whom to respond to in order to authenticate. At operation 10c, the sending entity device 602 sends an authentication request to the issuer 108.

The issuer 108 receives the message sent by the sending entity device 602 in operation 10c and analyzes its contents. At operation 11 c the issuer 108 communicates to the sending entity device 602 the CPN and requests the sending entity 102 provide a passcode or response to authenticate. The sending entity device 602 receives the communication sent in operation 11c and responds in operation 12c with a message comprising the passcode or response. The issuer 108 receives the passcode or response sent in operation 12c and verifies that it matches the passcode or response associated with the CPN. In operation 13c, the issuer 108 sends a message to the sending entity device 602 with the results of the authentication request.

Operations 14c, 15c, 16c, and 17c execute and loop continuously for a pre-determined amount of time, during and after operations 9c, 10c, 11 c, 12c, and 13c, to check the authentication status of the sending entity 102. After operation 8b, the merchant 104 is waiting for the sending entity 102 to authenticate with the issuer 108. At operation 14c, the merchant 104 sends a message to the payment processing network 106 requesting the status of the authentication. In an example embodiment, the message is an authentication status request message. The payment processing network 106 receives the message sent in operation 14c, and may send a message to the issuer in operation 15c requesting the status of the authentication. In an example embodiment, the message is an authentication status request message.

The issuer 108 may receive the message sent in operation 15c and analyze its contents. The issuer 108 may then send a message to the payment processing network 106, at operation 16c, indicating the authentication status. The authentication status may indicate that the authentication succeeded, has failed, is in process, or is waiting for a response from the sending entity 102. In an example embodiment, the message is an authentication status response message. The merchant 104 may receive the message sent in operation 17c and analyze the contents. If the merchant 104 determines that the authentication was successful, then in operations 18c, the merchant 104 continues with a payment transaction or money transfer and sends confirmation of the authentication to the sending entity device in operation 19c. If the authentication was not successful, is in process, or is waiting for a response from the sending entity device 602, then operations 14c-17c loop until a pre-determined time period expires.

After a sending entity successfully authenticates and completes the operations listed in FIGS. 3-6 the sending entity may continue with a payment transaction or money transfer. In a purchase transaction, a sending entity purchases a good or service at the merchant using a portable consumer device, which may be in the form of a credit card. The consumer's portable consumer device can interact with an access device such as a POS (point of sale) terminal at the merchant. For example, the sending entity may take the credit card and may swipe it through an appropriate slot in the POS terminal. Alternatively, the POS terminal may be a contactless reader, and the portable consumer device may be a contactless device such as a contactless card.

An authorization request message is then forwarded to an acquirer. After receiving the authorization request message, the authorization request message is then sent to the payment processing system. The payment processing system then forwards the authorization request message to the issuer of the portable consumer device.

After the issuer receives the authorization request message, the issuer sends an authorization response message back to the payment processing system to indicate whether or not the current transaction is authorized (or not authorized). The transaction processing system then forwards the authorization response message back to the acquirer. The acquirer then sends the response message back to the merchant.

After the merchant receives the authorization response message, the access device at the merchant may then provide the authorization response message for the consumer. The response message may be displayed by the POS terminal, or may be printed out on a receipt.

At the end of the day, a normal clearing and settlement process can be conducted by the transaction processing system. A clearing process is a process of exchanging financial details between and acquirer and an issuer to facilitate posting to a consumer's account and reconciliation of the consumer's settlement position. Clearing and settlement can occur simultaneously.

Embodiments of the invention are not limited to the specific examples described above.

In another example embodiment, the authentication steps from an issuer perspective may comprise receiving from a payment processing network a message comprising a primary account number and an authentication channel identifier, receiving from a sending entity, over an authentication channel described by the authentication channel identifier, a passcode, authenticating the sending entity with the passcode with respect to a portable consumer device associated with the primary account number, receiving a request for the sending entity's authentication status from the payment processing network and responding to the request with the sending entity's authentication status.

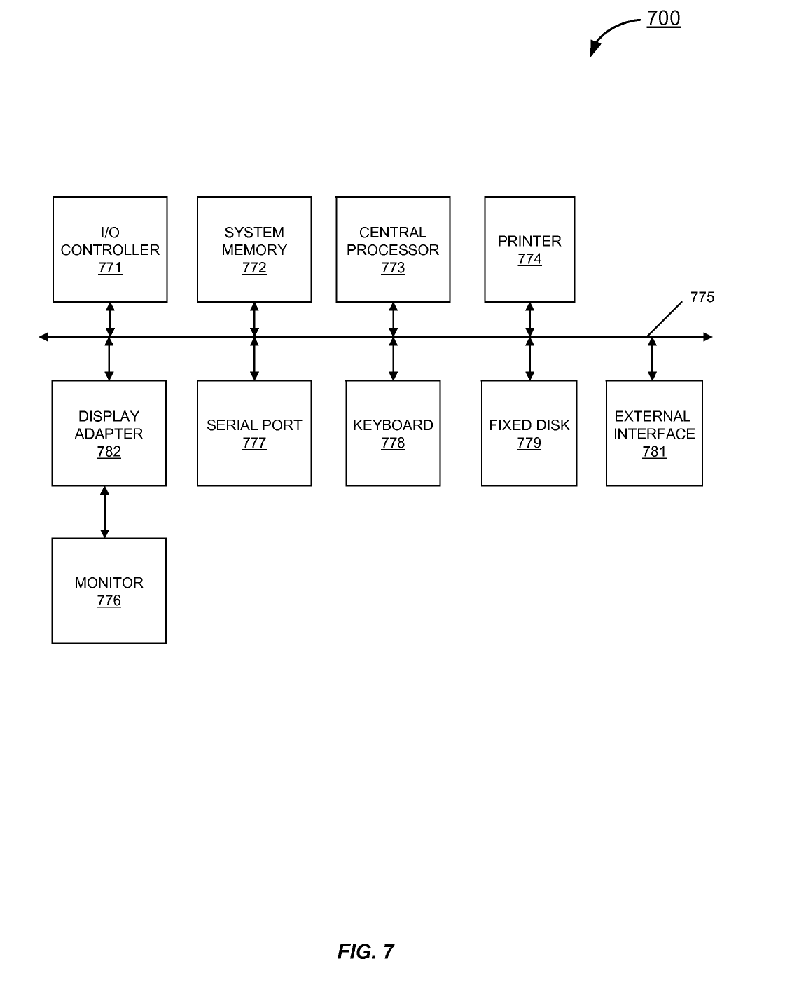

FIG. 7 is a diagram of a computer apparatus, according to an example embodiment. The various participants and elements in the previously described system diagrams (e.g., the merchant, issuer, access control server, third party authenticator, payment processing network, etc. in FIGS. 1, 2, 3, 4, 5, 6) may use any suitable number of subsystems in the computer apparatus to facilitate the functions described herein. Examples of such subsystems or components are shown in FIG. 7. The subsystems shown in FIG. 7 are interconnected via a system bus 775. Additional subsystems such as a printer 774, keyboard 778, fixed disk 779 (or other memory comprising computer-readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Embodiments of the remote variable authenticating processing system provides several advantages over existing systems. The remote variable authenticating processing system allows the send entity to authenticate without disclosing any sensitive information, such as a credit card number. The remote variable authenticating processing also allows the sending entity to select the authentication channel they wish to authenticate through, and provides separate processes depending upon the authentication channel selected. This increases the value of the authentication, as it may also verify that the user is in possession of a particular device. It may also increase the utility of the authentication system, as it allows users to authenticate using multiple methods. Also, compatible initiation channels and authentication channels may be determined or enforced.

What is claimed is:

1. A method comprising:
receiving from a participant a message comprising an alias;
determining one or more consumer payment nicknames associated with the alias; and
sending the one or more consumer payment nicknames and metadata associated with each of the one or more consumer payment nicknames to the participant, the metadata describing authentication channels through which authentication of the one or more consumer payment nicknames can be conducted, wherein the participant presents the one or more consumer payment nicknames and the authentication channels to a sending entity.

2. The method of claim 1, further comprising receiving from the participant an initiation channel identifier and analyzing the metadata to determine compatibility data describing which authentication channel is compatible with the channel described by the initiation channel identifier and sending the compatibility data to the participant.

3. The method of claim 1, wherein the participant is a merchant.

4. The method of claim 2, wherein the authentication channels incompatible with the channel described by the initiation channel identifier are not selectable by the sending entity.

5. The method of claim 2, wherein the authentication channels incompatible with the channel described by the initiation channel identifier are not presented to the sending entity.

6. The method of claim 2, wherein if only one consumer payment nickname and authentication channel is compatible with the initiation channel identifier, then that consumer payment nickname and authentication channel is used to authenticate the consumer payment nickname.

7. The method of claim 1, further comprising receiving a consumer payment nickname and an authentication channel from the participant, the consumer payment nickname and authentication channel being selected by the sending entity.

8. The method of claim 7, further comprising analyzing the received consumer payment nickname to determine an authorizing entity and sending an authentication request message comprising an authentication channel identifier to the authorizing entity.

9. The method of claim 8, further comprising receiving an authentication response message from the authorizing entity, and sending the authentication response message to the participant, wherein the participant will notify the sending entity via the initiation channel of the authentication response message.

10. A non-transitory computer readable medium comprising code that when executed by a processor performs the method of claim 1.

11. A system comprising
a processor; and
a computer-readable medium coupled to the processor, the computer readable medium comprising code executable by the processor for implementing a method comprising:
receiving from a participant a message comprising an alias;
determining one or more consumer payment nicknames associated with the alias; and
sending the one or more consumer payment nicknames and metadata associated with each of the one or more consumer payment nicknames to the participant, the metadata describing authentication channels through which authentication of the one or more consumer payment nicknames can be conducted, wherein the participant presents the one or more consumer payment nicknames and the authentication channels to a sending entity.

12. The system of claim 11, wherein the method further comprises receiving from the participant an initiation channel identifier and analyzing the metadata to determine compatibility data describing which authentication channel is compatible with the channel described by the initiation channel identifier and sending the compatibility data to the participant.

13. The system of claim 11, wherein the method further comprises receiving a consumer payment nickname and an authentication channel from the participant, the consumer payment nickname and authentication channel being selected by the sending entity.

14. The system of claim 13, wherein the method further comprises analyzing the received consumer payment nickname to determine an authorizing entity and sending an authentication request message comprising an authentication channel identifier to the authorizing entity.

15. A method comprising:
receiving from a payment processing network a message comprising a primary account number and an authentication channel identifier;
receiving from a sending entity, over an authentication channel described by the authentication channel identifier, a passcode;
authenticating the sending entity with the passcode with respect to a portable consumer device associated with the primary account number;
receiving a request for whether the sending entity successfully authenticated from the payment processing network; and
sending to the payment processing network whether the sending entity successfully authenticated.

16. The method of claim 15, further comprising sending a customer payment nickname associated with the primary account number and a request for the passcode to the sending entity.

17. The method of claim 15, further comprising sending a message to redirect the sending entity to a participant.

18. The method of claim 15, further comprising sending an authentication address to a payment processing network, the authentication address indicating where the sending entity may provide the passcode.

19. The method of claim 15, wherein the primary account number and authentication channel identifier are selected by the sending entity.

20. The method of claim 15, wherein the payment processing network sends the sending entity authentication status to a participant.
